(19) United States
(12) Patent Application Publication
(10) Pub. No.: US 2014/0146860 A1
(43) Pub. Date: May 29, 2014

(54) TRANSCEIVER WITH SHORT-CIRCUIT DETECTION AND PROTECTION

(71) Applicant: LSI CORPORATION, Milpitas, CA (US)

(72) Inventors: Bradley Wright, Fort Collins, CO (US); Srinivas Vura, San Jose, CA (US)

(73) Assignee: LSI Corporation, Milpitas, CA (US)

(21) Appl. No.: 13/686,455

(22) Filed: Nov. 27, 2012

(51) Int. Cl. H04B 1/40

(52) U.S. Cl. CPC H04B 1/40
USPC 375/219

(57) ABSTRACT

A USB transceiver has transmitter circuitry, receiver circuitry, short-circuit detection circuitry, and short-circuit protection circuitry. The transmitter circuitry transmits a differential pair of outgoing data signals to a cable connected to the transceiver, and the receiver circuitry receives the differential pair of outgoing data signals via bi-directional input-output pins. The short-circuit detection circuitry analyzes each of the outgoing differential data signals to detect a short circuit in the pair of outgoing data signals, and the short-circuit protection circuitry protects the transmitter circuitry upon detection of a short circuit.

### SUMMARY

In one embodiment, a transceiver comprises transmitter circuitry, receiver circuitry, short-circuit detection circuitry, and short-circuit protection circuitry. The transmitter circuitry transmits at least one outgoing signal to a cable connected to the transceiver, and the receiver circuitry receives the at least one outgoing signal. The short-circuit detection circuitry analyzes the at least one outgoing signal to detect a short circuit in the at least one outgoing signal, and the short-circuit protection circuitry protects the transmitter circuitry upon detection of the short circuit.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 shows a simplified block diagram of a transceiver of a Universal Serial Bus (USB) device or host according to one embodiment of the disclosure;

FIG. 2 shows a simplified block diagram of a short-circuit detection circuit according to one embodiment of the disclosure;

FIG. 3 shows Table I, which illustrates an exemplary first scenario in which only a signal path carrying a true data signal is shorted to ground;

FIG. 4 shows Table II, which illustrates an exemplary second scenario in which only a signal path carrying a complement data signal is shorted to ground;

FIG. 5 shows Table III, which illustrates an exemplary third scenario in which signal paths carrying both a true data signal and a complement data signal are shorted to ground; and

FIG. 6 shows a simplified block diagram of a short-circuit detection circuit according to another embodiment of the disclosure.

### DETAILED DESCRIPTION

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

The Universal Serial Bus (USB) engineering change notice titled 5V Short Circuit Withstand Requirement Change 5V (22 Dec. 2008) amended Universal Serial Bus Specification Revision 2.0 (27 Apr. 2000) (“the USB 2.0 specification”), both of which are incorporated herein by reference, to state that “A USB transceiver is required to withstand a continuous short circuit of D+ and/or D− to GND, other data line, or the cable shield at the connector, for a minimum of 24 hours without degradation,” where D+ and D− respectively refer to true and complement data signals. To meet this requirement, devices and resistors in the physical layer can be increased in size. However, such increase in size can drastically increase the silicone area and power required for a USB 2.0 device. Rather than, or in addition to, increasing the sizes of devices and resistors to withstand short circuits, USB transceivers can be implemented with logic to detect short circuits and disable the devices and resistors that are susceptible to damage from a short circuit, thereby reducing the amount of time that the circuitry must tolerate a shorted condition.

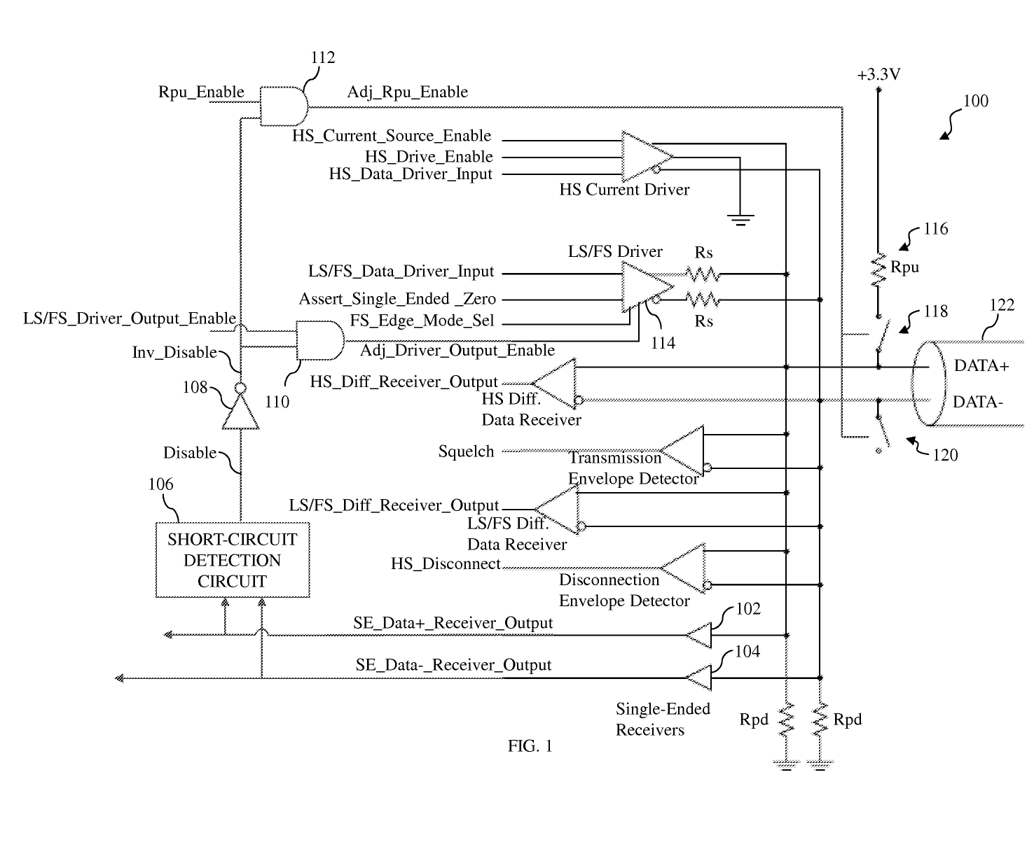

FIG. 1 shows a simplified block diagram of a transceiver 100 of a USB device according to one embodiment of the disclosure. Transceiver 100 comprises circuitry analogous to that shown in FIG. 7-1 of the USB 2.0 specification plus some additional circuitry comprising short-circuit detection circuit 106 and short-circuit protection circuitry that comprises inverter 108, and AND gates 110 and 112. The USB 2.0 specification provides an explanation of the rest of the components shown in FIG. 1 that are common between transceiver 100 and FIG. 7-1.

When transceiver 100 is in a normal low-speed (LS) or full-speed (FS) transmit mode, transceiver 100 transmits a differential pair of analog data signals comprising a true data signal Data+ and a complement data signal Data− to a remote USB transceiver (not shown) over USB cable 122. However, when one or both of the signal paths carrying the analog data signals Data+ and Data− is shorted to ground, the shorted path (or paths) experiences relatively high currents flowing through LS/FS driver 114 and pull-up resistor 116 that destroys the differential nature of the pair of analog signals Data+ and Data−.

To detect a short circuit to ground, a true-signal single-ended receiver 102 and a complement-signal single-ended receiver 104 of transceiver 100 converts the analog signals Data+ and Data−, respectively, to true and complement digital signals SE_Data+_Receiver_Output and SE_Data−_Receiver_Output, respectively. Note that the pins (not shown) connecting transceiver 100 to USB cable 122 are bi-directional input-output pins that allow single-ended receivers 102 and 104 to receive the analog data signals Data+ and Data−, respectively, transmitted by LS/FS driver 114.

The true and complement digital signals SE_Data+_Receiver_Output and SE_Data−_Receiver_Output are provided to short-circuit detection circuit 106, which detects a short circuit in one or both of the signal paths carrying the true and complement data signals Data+ and Data−. In general, short-circuit detection circuit 106, which is discussed in further detail below, detects whether or not a short circuit is present based on characteristic changes in the states of one or both of digital signals SE_Data+_Receiver_Output and SE_Data−_Receiver_Output while transceiver 100 is transmitting a packet. If the differential nature of signals Data+ and Data− has been destroyed, then a short circuit is detected, and short-circuit detection circuit 106 drives a disable signal Disable high.

The disable signal Disable is inverted by inverter 108 and provided to AND gate 110 along with an LS/FS driver enable signal LS/FS_Driver_Output_Enable, which is equivalent to LS/FS driver enable signal LS/FS_Driver_Output_Enable in the USB 2.0 specification. The LS/FS driver enable signal LS/FS_Driver_Output_Enable is driven high to turn on LS/FS driver 114 whenever transceiver 100 is in the transmit mode and driven low to turn off LS/FS driver 114 whenever transceiver 100 is not in the transmit mode. Whenever Disable is driven high, indicating the detection of a short circuit, AND gate 110 overrides the LS/FS driver enable signal LS/FS_Driver_Output_Enable by driving an adjusted enable signal Adj_Driver_Output_Enable low. As a result, the adjusted enable signal Adj_Driver_Output_Enable disables LS/FS driver 114, thereby protecting LS/FS driver 114 from processing excessively high currents.

The inverted disable signal Inv_Disable is also provided by inverter 108 to AND gate 112 along with a pull-up resistor (Rpu) enable signal Rpu_Enable, which is equivalent to Rpu enable signal Rpu_Enable in the USB 2.0 specification. Rpu enable signal Rpu_Enable is driven (i) high in low-speed and full-speed transmissions and during the Chirp sequence of the high-speed detection handshake to close switches 118 and 120, thereby coupling pull-up resistor 116 to the true and complement data signals Data+ and Data−, and (ii) low in high-speed transmissions to open switches 118 and 120, thereby de-coupling pull-up resistor 116. Whenever Disable is driven high, indicating the detection of a short circuit, AND gate 112 overrides the Rpu enable signal Rpu_Enable by driving an adjusted enable signal Adj_Rpu_Enable signal low. As a result, the adjusted enable signal Adj_Rpu_Enable opens switches 118 and 120, thereby de-coupling pull-up resistor 116 such that pull-up resistor 116 is protected from damage.

In one implementation, digital signals SE_Data+_Receiver_Output and SE_Data−_Receiver_Output received by short-circuit detection circuit 106 are each non-return-to-zero inverted (NRZI) encoded signals. The NRZI encoding is performed by the remote transceiver that generates the analog true and complement data signals Data+ and Data−. In NRZI encoding, a bit value of one is represented by no change in state and a bit value of zero is represented by a change in state (i.e., from high to low or low to high). Thus, when a string of consecutive zeros is NRZI-encoded, the NRZI-encoded signal toggles between high and low states. However, when a string of consecutive ones is NRZI-encoded, the NRZI-encoded signal does not toggle resulting in periods where there are no transitions in the data signal.

In USB systems, the receiver relies on transitions in the data signal to obtain data and clock lock. Thus, in order to ensure adequate signal transitions, the USB 2.0 specification employs bit stuffing, wherein a zero is inserted after every six consecutive ones in the data stream before the data is NRZI encoded. The zero is a non-information bit that is added for the purpose of ensuring that a data transition occurs at least once every seven bit periods.

When the true data signal Data+ or the complement data signal Data− is shorted to ground, the NRZI-encoding of that signal is lost. As a result, the corresponding digital signal SE_Data+_Receiver_Output or SE_Data−_Receiver_Output does not toggle and comprises only zeros. Short-circuit detection circuit 106 exploits the fact that the NRZI encoding of USB should transition from state to state in order to detect whether or not a short circuit is present. If either or both of signals SE_Data+_Receiver_Output and SE_Data−_Receiver_Output do not transition for a specified number of bit periods (e.g., eight or more), then short-circuit detection circuit 106 detects a short circuit.

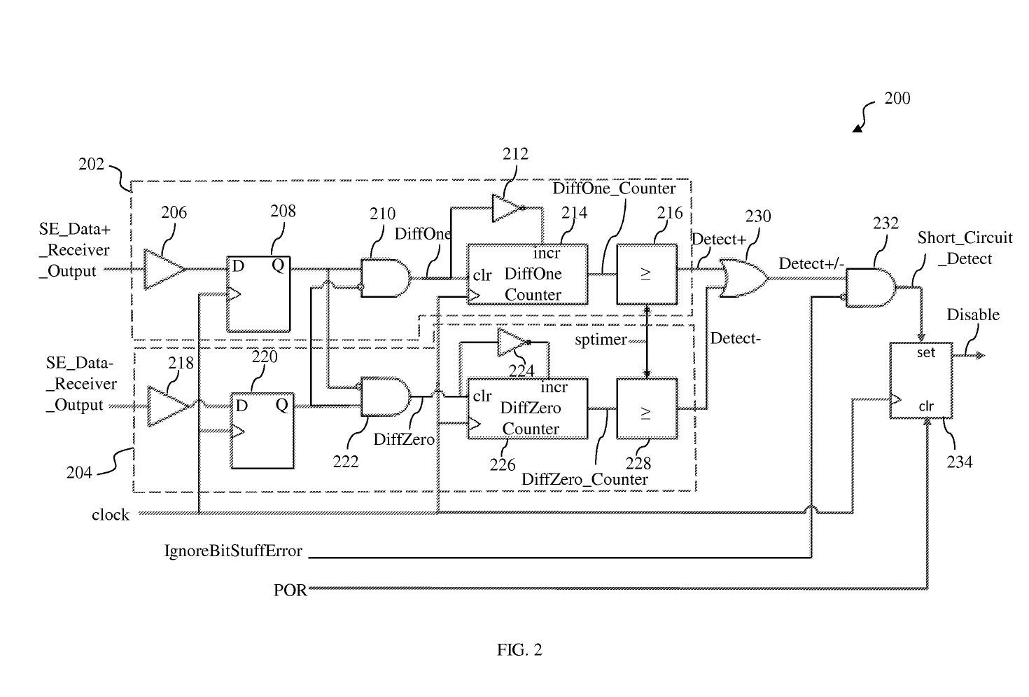

FIG. 2 shows a simplified block diagram of a short-circuit detection circuit 200 according to one embodiment of the disclosure. Short-circuit detection circuit 200, which may be used to implement short-circuit detection circuit 106 of FIG. 1, comprises an upper path 202 that detects whether a short circuit is present on the signal path carrying true data signal Data+ based on digital signal SE_Data+_Receiver_Output and a lower path 204 that detects whether a short circuit is present on the signal path complement data signal Data− based on digital signal SE_Data−_Receiver_Output.

On the upper path 202, digital signal SE_Data+_Receiver_Output is buffered by buffer 206 and the state of true digital signal SE_Data+_Receiver_Output during each bit period is stored by flip-flop 208. Similarly, on the lower path 204, digital signal SE_Data−_Receiver_Output is buffered by buffer 218 and the state of complement digital signal SE_Data+_Receiver_Output during each bit period is stored by flip-flop 220. Typically, the states of digital signals SE_Data+_Receiver_Output and SE_Data−_Receiver_Output themselves do not represent bit values. Rather, as described above, a bit value of zero is represented by a change in the state of digital signals SE_Data+_Receiver_Output and SE_Data−_Receiver_Output and a bit value of one is represented by no change in the state of digital signals SE_Data+_Receiver_Output and SE_Data−_Receiver_Output.

To detect short circuits in true data signal Data+, AND gate 210 of upper path 202 performs logical conjunction on each state of digital signal SE_Data+_Receiver_Output and the inverse of each corresponding state of digital signal SE_Data−_Receiver_Output (as indicated by the small circle at the lower input of AND gate 210) to generate a value DiffOne. Since Data+ and Data− are differential signals, the value of SE_Data+_Receiver_Output and the inverse of SE_Data+_Receiver_Output should always be the same. AND gate 210 sets the DiffOne value equal to zero each time that (i) the values of SE_Data+_Receiver_Output and the inverse of SE_Data−_Receiver_Output are not the same, indicating that the differential signaling is lost, or (ii) the value of digital signal SE_Data+_Receiver_Output is zero, indicating that the NRZI-encoding of SE_Data+_Receiver_Output could possibly be lost. Each time that the DiffOne value is equal to zero, inverter 212 provides an inverted DiffOne value equal to one to DiffOne counter 214, which increments a DiffOne_Counter value by one. Each time that the DiffOne value is equal to one, DiffOne counter 214 resets the DiffOne_Counter value to zero.

Each bit period, the DiffOne_Counter value generated by DiffOne counter 214 is compared by comparator 216 to a specified threshold value sptimer, where sptimer is greater than seven (e.g., eight or more) and may be determined empirically. If the DiffOne_Counter value is less than the threshold value sptimer, then upper path 202 does not detect a short circuit, and comparator 216 drives a true detection signal detect+ low. If the DiffOne_Counter value reaches the threshold value sptimer, then upper path 202 detects a short circuit, and comparator 216 drives the true detection signal detect+ high. Once a short circuit is detected, the true detection signal detect+remains in a high state until DiffOne counter 214 resets the DiffOne_Counter value.

Lower path 204 comprises components 218-228, which operate in a manner analogous and complementary to components 206-216 of upper path 202 to detect short circuits on the signal path carrying complement data signal Data−and generate complement detection signal detect−.

If either or both of the detection signals detect+ and detect− are in a high state, then OR gate 230 drives a combined detection signal detect+/− high. The combined detection signal is provided to AND gate 232 along with the inverse of an IgnoreBitStuffError signal. Typically, the IgnoreBitStuffError signal is driven low during transmissions where bit stuffing is performed without error. However, whenever there is a bit-stuffing error that might prevent digital signal SE_Data+_Receiver_Output and/or digital signal SE_Data−_Receiver_Output from toggling, the IgnoreBitStuffError signal is driven high. The bit-stuffing error can be the result of, for example, the USB transmitter 100 receiving insufficient user data when transmitting a packet to USB cable 122. Applying both the combined detection signal detect+/− and the IgnoreBitStuffError signal to AND gate 232 prevents short-circuit detection circuit 200 from inadvertently detecting a bit-stuffing error as a short circuit, and consequently, prevents LS/FS driver 114 and pull-up resistor 116 of transceiver 100 from being disabled.

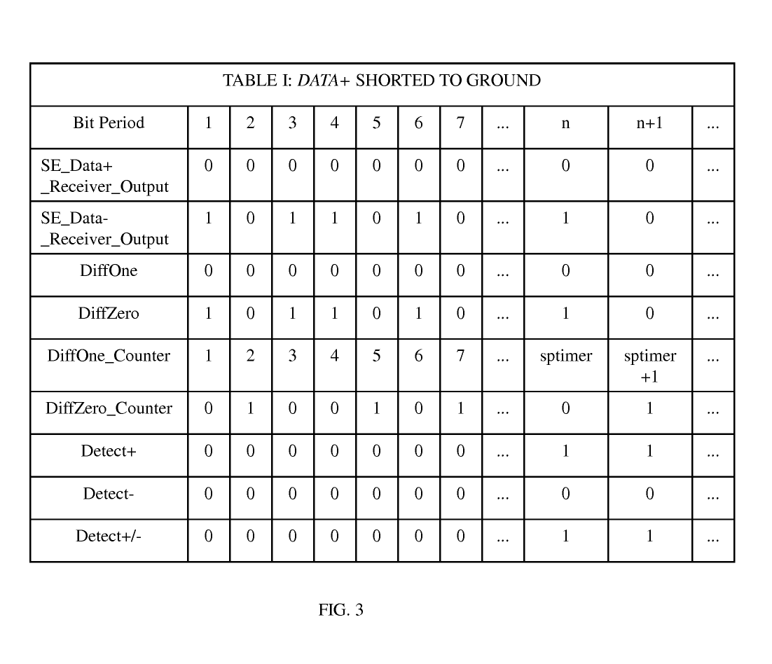

AND gate 232 provides short-circuit detection signal Short_Circuit_Detect to flip-flop 234. When short-circuit detection signal Short_Circuit_Detect is driven high, flip flop 234 drives the disable signal Disable high. The disable signal Disable remains high until a power-on-reset signal POR is driven high. The power-on-reset signal POR is the master reset to the chip on which transceiver 100 resides and is usually driven high once power is applied to the chip. To further understand the operation of short-circuit detection circuit 200, consider FIGS. 3-5.

FIG. 3 shows Table I, which illustrates an exemplary first scenario in which only the signal path carrying true data signal Data+ is shorted to ground. In this first scenario, the threshold value sptimer is set to some value n greater than 7. As shown, true digital signal SE_Data+_Receiver_Output comprises a string of zeros, and complement digital signal SE_Data−_Receiver_Output toggles between zero and one. On upper path 202, AND gate 210 outputs DiffOne values that are all zero, and DiffOne counter 214 increments the DiffOne_Counter value by one each bit period. At bit period n, comparator 216 determines that the DiffOne_Counter value is equal to threshold value sptimer, and as a result, true detection signal detect+ is driven high. True detection signal detect+ remains high as long as the DiffOne_Counter value does not reset and continues to increase above the threshold value sptimer.

On lower path 204, AND gate 222 outputs DiffZero values that toggle between zero and one. As a result, DiffZero counter 226 resets the DiffZero_Counter value every time a DiffZero value of one is received, such that the DiffZero_Counter value is not permitted to increase to the threshold value sptimer, and complement detection signal detect− remains low. At bit period n, OR gate 230 drives the combined detection signal detect+/− high due to true detection signal detect+ being driven high. The combined detection signal remains high as long as the DiffOne_Counter value does not reset and continues to increase above the threshold value sptimer.

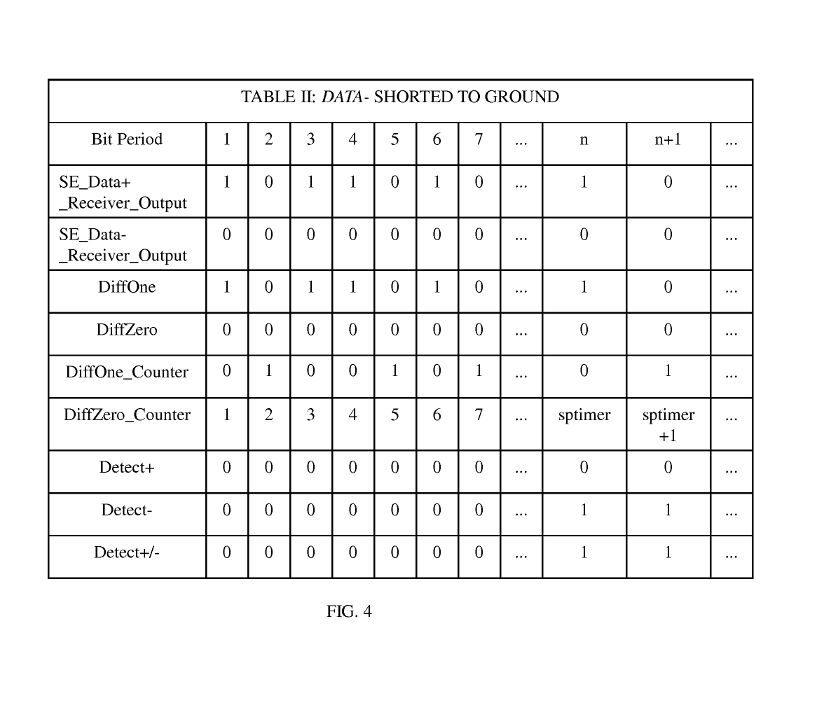

FIG. 4 shows Table II, which illustrates an exemplary second scenario in which only the signal path carrying complement data signal Data− is shorted to ground. In this second scenario, the threshold value sptimer is set to some value n greater than 7. As shown, true digital signal SE_Data+_Receiver_Output toggles between zero and one, and complement digital signal SE_Data−_Receiver_Output comprises a string of zeros. On upper path 202, AND gate 210 outputs DiffOne values that toggle between zero and one. As a result, DiffOne counter 214 resets the DiffOne_Counter value every time a DiffOne value of one is received, such that the DiffOne_Counter value is not permitted to increase to the threshold value sptimer, and true detection signal detect+ remains low.

On lower path 204, AND gate 222 outputs DiffZero values that are all zero, and DiffZero counter 226 increments the DiffZero_Counter value by one each bit period. At bit period n, comparator 228 determines that the DiffZero_Counter value is equal to threshold value sptimer, and as a result, complement detection signal detect− is driven high, and OR gate 230 drives the combined detection signal detect+/− high. Complement detection signal detect− and combined detection signal detect+/− remain high as long as the DiffZero_Counter value is not reset and continues to increase above the threshold value sptimer.

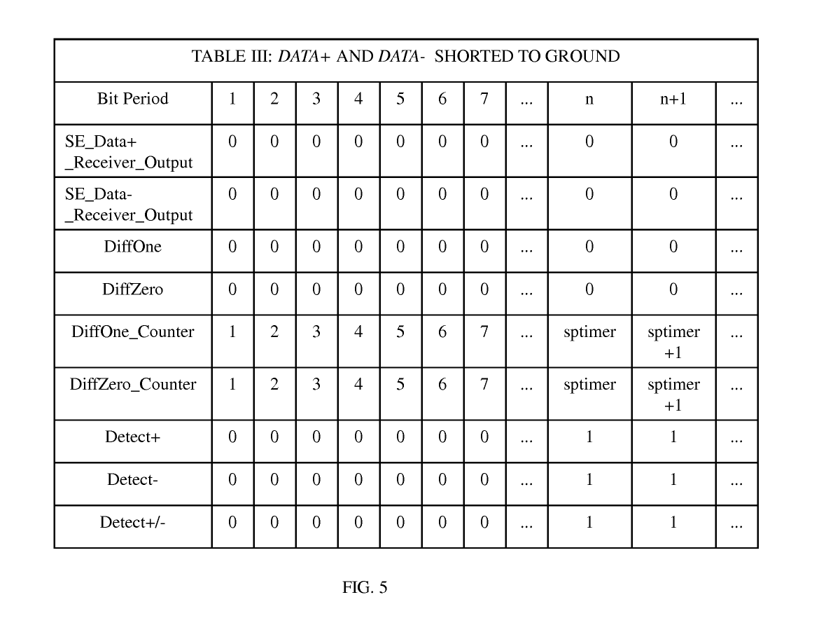

FIG. 5 shows Table III, which illustrates an exemplary third scenario in which both the true data signal Data+ and the complement data signal Data− are shorted to ground. In this third scenario, the threshold value sptimer is set to some value n greater than 7. As shown, both digital signals SE_Data+_Receiver_Output and SE_Data−_Receiver_Output comprise a string of zeros. On upper path 202, AND gate 210 outputs DiffOne values that are all zero, and DiffOne counter 214 increments the DiffOne_Counter value by one each bit period. Similarly, on lower path 204, AND gate 222 outputs DiffZero values that are all zero, and DiffZero counter 226 increments the DiffZero_Counter value by one each bit period. At bit period n, comparators 216 and 228 determine that the DiffOne_Counter value and the DiffZero_Counter value, respectively, are equal to threshold value sptimer. As a result, detection signals Detect+ and Detect− and combined detection signal Detect+/− are driven high. All three signals remain high as long as the DiffOne_Counter and DiffZero_Counter values are not reset and continue to increase above the threshold value sptimer.

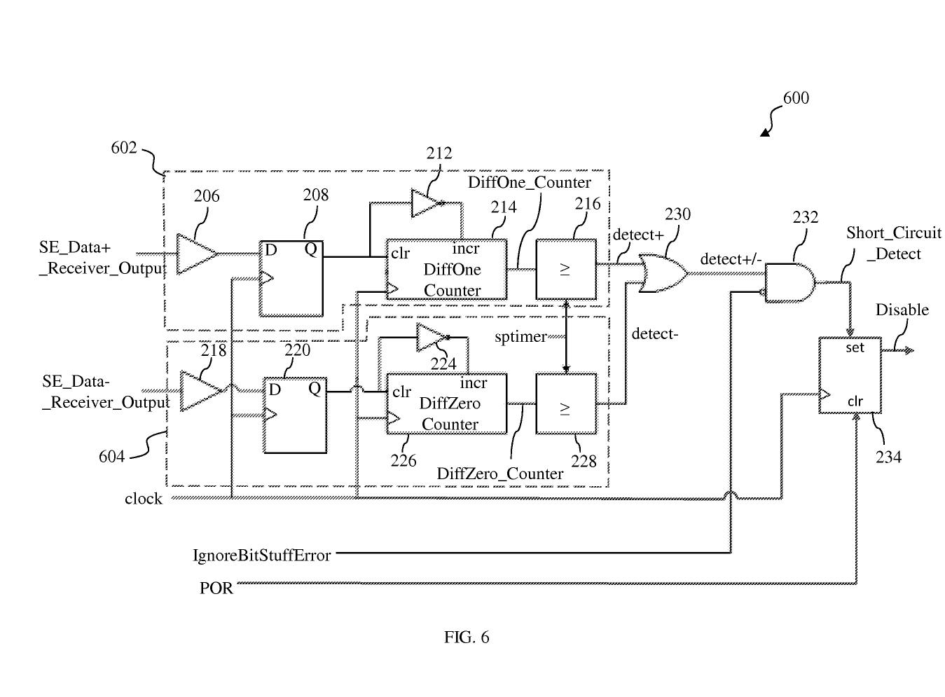

FIG. 6 shows a simplified block diagram of a short-circuit detection circuit 600 according to another embodiment of the disclosure. The only differences between short-circuit detection circuit 600 and short-circuit detection circuit 200 of FIG. 2 are that (i) upper path 602 of short-circuit detection circuit 600 does not comprise AND gate 210 and (ii) lower path 604 of short-circuit detection circuit 600 does not comprise AND gate 222. Thus, flip-flop 208 provides each state of true digital signal SE_Data+_Receiver_Output directly to the control port of DiffOne counter 214 and inverter 212, and flip-flop 220 provides each state of complement digital signal SE_Data−_Receiver_Output directly to the control port of DiffZero counter 226 and inverter 224.

In operation, short-circuit detection circuit 600 operates in a manner similar to that of short-circuit detection circuit 200. In particular, DiffOne counter 214 increments the DiffOne_Counter value each time the state of SE_Data+_Receiver_Output is low and resets when the state is high. Similarly, DiffZero counter 226 increments the DiffZero_Counter value when the state of SE_Data−_Receiver_Output is low and resets when the state is high.

Although some embodiments of the disclosure were described as detecting a short circuit in a USB 2.0 system, embodiments of the disclosure are not so limited. Alternative embodiments of the disclosure may be implemented in other USB systems and in non-USB systems that employ a differential pair of digital signals.

Further, although some embodiments of the disclosure were described relative to their use with NRZI encoding, embodiments of the disclosure are not so limited. Alternative embodiments of the disclosure may be implemented in systems that use encoding other than NRZI encoding such as non-return-to-zero (NRZ) encoding and non-return-to-zero-space encoding.

According to various alternative embodiments, short-circuit detection circuits of the disclosure can be implemented to detect a short circuit in as few as one data signal and or in more than two data signals. In embodiments that detect a short circuit in only one data signal, such embodiments may be implemented with only one detection path such as upper path 202 or lower path 204 and without an OR gate such as OR gate 230. In embodiments that detect a short circuit in more than two data signals, such embodiments may be implemented with one detection path per data signal and appropriate logic to combine the outputs from those different detection paths.

Although FIGS. 2 and 6 show two specific embodiments for counting the states of digital data signals, embodiments of disclosure are not so limited. One of ordinary skill in the art would recognize that there are many different methods that can be used to characterize and count the states of digital signals. Various embodiments of the disclosure may be implemented using these different methods.

Further, although FIGS. 2 and 6 were described as implementing a single threshold sptimer, embodiments of the disclosure are not so limited. According to alternative embodiments, the thresholds used for upper paths 202 and 602 could be different from the thresholds used for lower paths 204 and 604.

Note that, as used herein, the term “transceiver” refers to the combination of a transmitter and a receiver implemented at a single network node.

Although certain embodiments of the disclosure were described as detecting short circuits to ground, embodiments of the disclosure are not so limited. Various embodiments of the disclosure may be implemented to detect short circuits to high voltages. For example, some such embodiments may be implemented by counting the number of times that SE_Data+_Receiver_Output and/or SE_Data−_Receiver_Output are high.

Embodiments of the disclosure may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

Embodiments of the disclosure can be manifest in the form of methods and apparatuses for practicing those methods. Embodiments of the disclosure can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the embodiment. Embodiments of the disclosure can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing the embodiment. When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A transceiver comprising:
transmitter circuitry configured to transmit at least one outgoing signal to a cable connected to the transceiver;
receiver circuitry configured to receive the at least one outgoing signal;
short-circuit detection circuitry configured to analyze the at least one outgoing signal to detect a short circuit in a signal path carrying the at least one outgoing signal; and
short-circuit protection circuitry configured to protect the transmitter circuitry upon detection of the short circuit.

2. The transceiver of claim 1, wherein:
the transmitter circuitry is configured to transmit an outgoing differential pair of outgoing signals to the cable;
the receiver circuitry is configured to receive the outgoing differential pair of outgoing signals; and
the short-circuit detection circuitry is configured to analyze each outgoing signal in the outgoing differential pair to detect a short circuit in one or both of the outgoing signals in the outgoing differential pair.

3. The transceiver of claim 2, wherein the short-circuit detection circuitry comprises:
a first counter configured to generate a first count corresponding to a number of consecutive instances that a first outgoing signal of the differential pair does not change state;
a second counter configured to generate a second count corresponding to a number of consecutive instances that a second outgoing signal of the differential pair does not change state;
a first comparator configured to compare the first count to a first specified threshold value; and
a second comparator configured to compare the second count to a second specified threshold value, wherein the short-circuit protection circuitry detects the short circuit based on the comparisons of the first and the second comparators.

4. The transceiver of claim 3, wherein the short-circuit detection circuitry detects the short circuit if (i) the first count exceeds the first specified threshold, (ii) the second count exceeds the second specified threshold, or (iii) the first count exceeds the first specified threshold and the second count exceeds the second specified threshold.

5. The method of claim 4, wherein the first specified threshold and the second specified threshold are the same.

6. The transceiver of claim 1, wherein:
the transmitter circuitry comprises a driver configured to drive the at least one outgoing signal; and
the short-circuit protection circuitry is configured to disable the driver to protect the transmitter circuitry upon detection of the short circuit.

7. The transceiver of claim 1, wherein:
the transmitter circuitry comprises a pull-up resistor; and
the short-circuit protection circuitry is configured to disable the pull-up resistor to protect the transmitter circuitry upon detection of the short circuit.

8. The transceiver of claim 1, wherein:
the receiver circuitry comprises at least one single-ended receiver configured to convert the at least one outgoing signal into at least one digital signal; and
the short-circuit detection circuitry is configured to analyze the at least one digital signal to detect the short circuit.

9. The transceiver of claim 8, wherein the short-circuit detection circuitry is configured to characterize a number of consecutive instances that the at least one digital signal does not change state.

10. The transceiver of claim 9, wherein the at least one digital signal is an non-return-to-zero-inverted-encoded signal generated by the transmitter.

11. The transceiver of claim 8, wherein the short-circuit detection circuitry comprises:
a counter configured to generate a count of a number of consecutive instances that the at least one digital signal does not change state; and
a comparator configured to compare the count to a specified threshold value to detect the short circuit.

12. The transceiver of claim 1, wherein the transceiver is a Universal Serial Bus transceiver.

13. A method implemented in a transceiver, the transceiver comprising:
transmitter circuitry configured to transmit at least one outgoing signal to a cable connected to the transceiver; and
receiver circuitry configured to receive the at least one outgoing signal, wherein the method comprises:
(a) analyzing the at least one outgoing signal to detect a short circuit in a signal path carrying the at least one outgoing signal; and
(b) protecting the transmitter circuitry upon detection of the short circuit.

14. The method of claim 13, wherein:
the transmitter circuitry is configured to transmit an outgoing differential pair of outgoing signals to the cable;
the receiver circuitry is configured to receive the outgoing differential pair of outgoing signals; and
step (a) comprises analyzing each outgoing signal in the outgoing differential pair to detect a short circuit in one or both of the outgoing signals in the outgoing differential pair.

15. The method of claim 14, wherein step (a) comprises:
(a1) generating a first count corresponding to a number of consecutive instances that a first outgoing signal of the differential pair does not change state;
(a2) generating a second count corresponding to a number of consecutive instances that a second outgoing signal of the differential pair does not change state;
(a3) comparing the first count to a first specified threshold value;
(a4) comparing the second count to a second specified threshold value; and
(a5) detecting the short circuit based on the comparisons of steps (a3) and (a4).

16. The method of claim 15, wherein step (a5) comprises detecting the short circuit if (i) the first count exceeds the first specified threshold, (ii) the second count exceeds the second specified threshold, or (iii) the first count exceeds the first specified threshold and the second count exceeds the second specified threshold.

17. The method of claim 16, wherein the first specified threshold and the second specified threshold are the same.

18. The method of claim 13, wherein:
the transmitter circuitry comprises a driver configured to drive the at least one outgoing signal; and
step (b) comprises disabling the driver to protect the transmitter circuitry upon detection of the short circuit.

19. The method of claim 13, wherein:
the transmitter circuitry comprises a pull-up resistor; and
step (b) comprises disabling the pull-up resistor to protect the transmitter circuitry upon detection of the short circuit.

20. The method of claim 13, wherein step (a) comprises:
(a1) converting the at least one outgoing signal into at least one digital signal; and
(a2) analyzing the at least one digital signal to detect the short circuit.

21. The method of claim 20, wherein:
the at least one digital signal is an non-return-to-zero-inverted-encoded signal generated by the transmitter; and
step (a2) comprises characterizing a number of consecutive instances that the at least one digital signal does not change state.

22. The method of claim 20, wherein step (a2) comprises:
(a2i) generating a count of a number of consecutive instances that the at least one digital signal does not change state; and
(a2ii) comparing the count to a specified threshold value to detect the short circuit.
